(19) United States
(12) Patent Application Publication
(10) Pub. No.: US 2022/0103362 A1
(43) Pub. Date: Mar. 31, 2022

(54) BIOMETRIC-BASED IDENTITY AUTHENTICATION

(71) Applicant: 214 Technologies Inc., Los Angeles, CA (US)

(72) Inventors: Nezare CHAFNI, Santa Monica, CA (US); Shaun MOORE, Siesta Key, FL (US)

(73) Assignee: 214 Technologies Inc., Los Angeles, CA (US)

(21) Appl. No.: 17/120,004

(22) Filed: Dec. 11, 2020

Related U.S. Application Data
(60) Provisional application No. 63/085,880, filed on Sep. 30, 2020.

(51) Int. Cl. H04L 9/32; H04L 9/30; H04L 9/00; G06K 7/14; G06K 7/10; G07C 9/00; G06K 9/00

(52) U.S. Cl. CPC H04L 9/3231; H04L 9/30; H04L 9/008; G06K 7/1417; G06K 7/10366; H04L 67/20; G07C 9/00182; G07C 9/00563; G06K 9/00255; G06K 9/00604; G06K 9/00013; G06K 7/10297

(57) ABSTRACT

A method of enrolling in an authentication system may include obtaining biometric data of a user, and generating a biometric template vector using the biometric data. The enrolling method may also include encrypting the biometric template vector, and embedding the encrypted biometric template vector into a computer-scannable medium. An additional method of verification via an authentication system may include obtaining an encrypted and encoded form of a biometric template vector associated with a user. The verification method may also include decoding the biometric template vector, and obtaining biometric data of the user of a same form used to create the biometric template vector. The verification method may additionally include determining a similarity score between the decoded biometric template vector and the biometric data, and performing an action based on the similarity score.

### CROSS-REFERENCE TO RELATED APPLICATION

This application claims priority to and the benefit of U.S. provisional application No. 63/085,880, filed Sep. 30, 2020, entitled SECURITY VERIFICATION USING BIOMETRIC CHARACTERISTICS, which is incorporated herein by reference in its entirety.

### FIELD

Embodiments of the present disclosure relate to biometric-based identity authentication.

### BACKGROUND

Retinal scans, voice patterns, and other biometric-based user identity verification have been used to authenticate the identity of a user. Additionally, facial recognition and other biometric-based user authentications have gained traction in certain industries. However, there are shortcomings to such approaches, such as the storage of sensitive data and limitations on where such approaches can be used.

### SUMMARY

One or more embodiments of the present disclosure may include a method of enrolling in an authentication system, the method including obtaining biometric data of a user, and generating a biometric template vector using the biometric data. The method may also include encrypting the biometric template vector, and embedding the encrypted biometric template vector into a computer-scannable medium.

One or more additional embodiments of the present disclosure may include a method of verification via an authentication system, the method including obtaining an encrypted and encoded form of a biometric template vector associated with a user. The method may also include decoding the biometric template vector, and obtaining biometric data of the user of a same form used to create the biometric template vector. The method may additionally include determining a similarity score between the decoded biometric template vector and the biometric data, and performing an action based on the similarity score.

The object and advantages of the embodiments will be realized and achieved at least by the elements, features, and combinations particularly pointed out in the claims.

It is to be understood that both the foregoing general description and the following detailed description are merely examples and explanatory and are not restrictive.

### BRIEF DESCRIPTION OF THE DRAWINGS

Example embodiments will be described and explained with additional specificity and detail through the use of the accompanying drawings in which:

FIG. 1 is a diagram illustrating an example system which may facilitate biometric-based identity authentication;

FIGS. 2A-2I are example representations of various environments within which biometric-based identity authentication may be used;

FIG. 3 illustrates an example flowchart of an example method of enrolling in an authentication system;

FIG. 4 illustrates an example flowchart of an example method of verification via an authentication system;

FIG. 5A illustrates an example flowchart of an example method of verification via an authentication system using an asymmetric encryption scheme;

FIG. 5B illustrates an example flowchart of an example method of verification via an authentication system using a homomorphic encryption scheme;

FIG. 6 illustrates an example flowchart of an example method of verification via an authentication system using a partial biometric template vector;

FIG. 7 illustrates an example computing system.

### DETAILED DESCRIPTION

The present disclosure relates to the use of biometric data to verify the identity of an individual. During an enrollment phase, using a facial scan, voice recording, or other biometric user data, a computer-scannable medium may be generated that includes a biometric template vector (e.g., an encoded and/or encrypted data representation of the biometric user data). The biometric template vector may be affixed to an object as a quick response (QR) code, a radio frequency identification (RFID) chip, a near-field communication (NFC) tag, a credit card electronic chip, etc. During a verification phase, biometric data of a same form as that used to generate the biometric template vector may be obtained. The obtained biometric data and the biometric template vector may be compared to validate the identity of the user. Based on the biometric template vector and the biometric data obtained during the verification phase belonging to the same individual, an action may be taken (e.g., granting access to a location, starting a vehicle, authorizing a transaction, displaying a result of the verification, etc.).

Certain embodiments of the present disclosure may provide improvements over previous iterations of identity validation/verification. For example, one or more embodiments of the present disclosure may permit the user of a QR code or other computer-scannable data to facilitate user-identity verification. As another example, embodiments of the present disclosure may provide a more secure interaction between parties by permitting limited exposure of information, for example, when using a homomorphic encryption scheme. In particular, a challenger may be able to verify an identity of a user in a reliable manner while the user does not have to disclose additional information about the user to validate the attribute. Additionally, embodiments of the present disclosure permits verifying identities of individuals without storing personal data of the user to be verified. Instead, one or more embodiments contemplate reading an encrypted form of biometric data and capturing biometric data for comparison, performing a validation, and discarding the data without ever storing the data beyond performing these operations.

One or more example embodiments are explained with reference to the accompanying drawings.

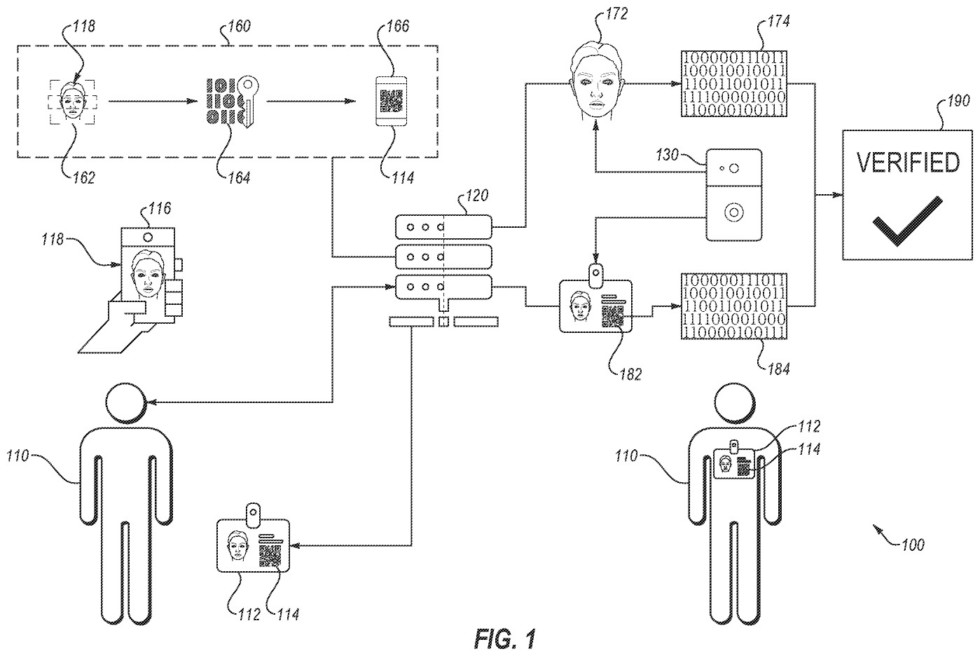

FIG. 1 is a diagram illustrating an example system 100 which may facilitate biometric-based identity authentication, in accordance with one or more embodiments of the present disclosure.

The system 100 may include a user 110 that may enroll with a service 120, and the service 120 may generate a quick response (QR) code 114 or other computer-scannable media that encodes biometric information of the user 110, such as a facial image 118 of the user 110. The user 110 may use the QR code 114 at an access device 130 to verify the identity of the user 110 by the service 120. For example, the access device 130 may capture a facial image 172 of the user 110 and scan the QR code 114 to compare the two and validate the identity of the user 110.

### Enrollment

When enrolling, the user 110 may generate and/or obtain biometric data associated with the user 110. For example, the user 110 may utilize a mobile device 116 or other electronic device with a camera to capture the facial image 118 of the user 110. Additionally or alternatively, the user 110 may obtain a voice recording, a retinal scan, a fingerprint, or any other biometric data associated with the user 110 that is unique to the user 110. After obtaining the facial image 118 (and/or other biometric data), the user 110 may provide the facial image 118 to the service 120.

The service 120 may include any computer, device, system, component, organization, etc. that may facilitate the use of biometric-based authentication of the identity of the user 110. For example, the service 120 may include one or more servers, applications, apps, or other processes or systems that may facilitate the enrollment and verification of the user 110.

In some embodiments, the service 120 may include a back-end server that may facilitate enrollment of the user 110, for example, via an application programming interface (API). For example, the user 110 may capture the facial image 118 on the mobile device 116 using an app on the mobile device 116. The mobile device 116 may invoke an enrollment API that provides as an input the captured facial image 118. The mobile device 116, via the enrollment API call, may transmit the facial image 118 to a back end server of the service 120 for analysis, processing, encoding, encryption, etc., such as enrollment processing 160. The result of the API may return the QR code 114 and/or another computer-scannable medium.

The enrollment processing 160 may include any operations, processes, calculations, analysis, etc. that may facilitate the transition of biometric data of the user 110 (such as the facial image 118) into computer-scannable data (such as the QR code 114). The enrollment processing 160 may include a vectorization step 162, an encryption/encoding step 164, and an embedding step 166.

The vectorization step 162 may convert the biometric data into a mathematical representation of the biometric data, which may be referred to as a biometric template vector. In some embodiments, such a representation may include a set number of floating point values, such as five hundred and twelve.

The encryption/encoding step 164 may perform additional processing on the biometric template vector. For example, the encryption/encoding step 164 may include a compression of the biometric template vector and a re-expansion of the biometric template vector. As another example, the encryption/encoding step 164 may include a quantization of the biometric template vector. In some embodiments, the encryption/encoding step 164 may include encrypting the biometric template vector using an asymmetric encryption scheme. For example, the biometric template vector may be encrypted using a public key associated with the service 120 such that the service 120 may decrypt the biometric template vector using a private key associated with the service 120. In some embodiments, the encryption/encoding step 164 may include encrypting the biometric template vector using a homomorphic encryption scheme. For example, the biometric template vector may be encrypted such that certain mathematical operations (such as a comparison with a same value encrypted in the same manner and/or using the same encryption keys) may be performed on an encrypted form of the biometric template vector without decrypting the biometric template vector.

The embedding step 166 may embed the encoded and/or encrypted biometric template vector of the biometric data into a computer-scannable form (such as the QR code 114). For example, the output of the encryption/encoding step 164 may undergo processing to convert the output into a QR code (or other visual barcode/scannable representation of data), an RFID tag, an NFC chip, a credit card chip, a magnetic strip, etc. In these and other embodiments, the service 120 may provide the QR code 114 to the user 110.

While illustrated as being performed on a back-end server, it will be appreciated that one or more of the operations of the enrollment processing 160 may be performed locally by a device of the user 110 (such as the mobile device 116 of the user 110). For example, an app on the mobile device 116 may include programming to perform the enrollment processing 160 such that a QR code 114 (or other computer-scannable media) may be obtained with or without communicating to another device. In some embodiments, a single device able to capture the biometric data and perform the enrollment processing 160 may perform an entire enrollment phase consistent with the present disclosure. Additionally or alternatively, some operations may be performed at the mobile device 116 and some may be performed by a back-end server.

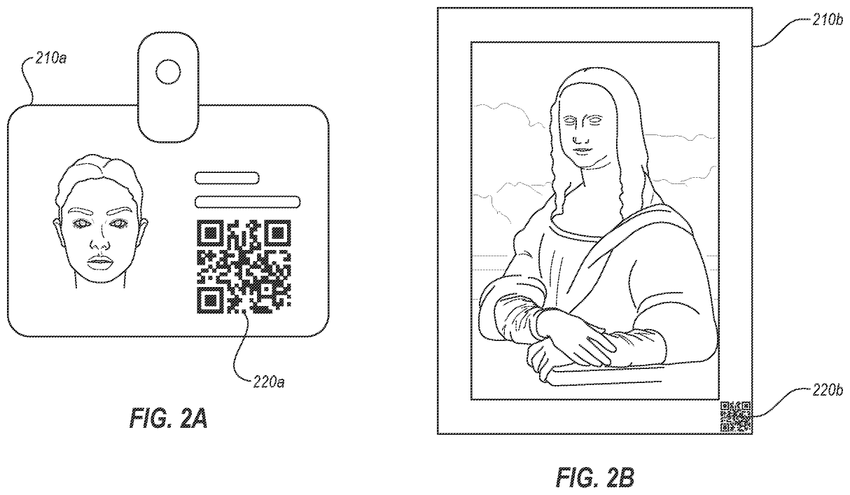

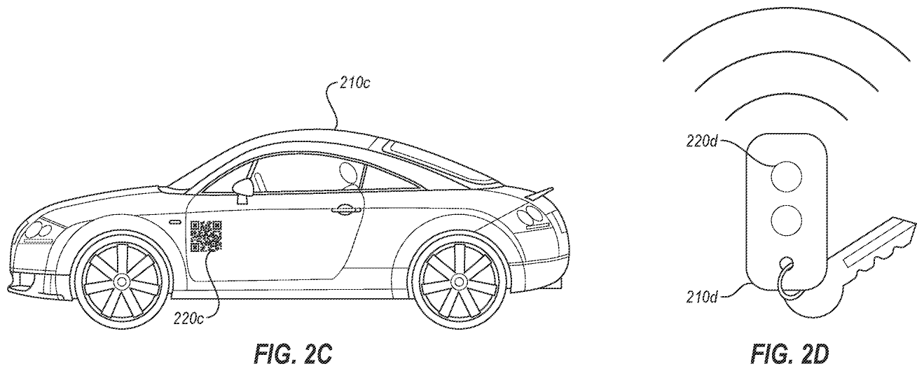

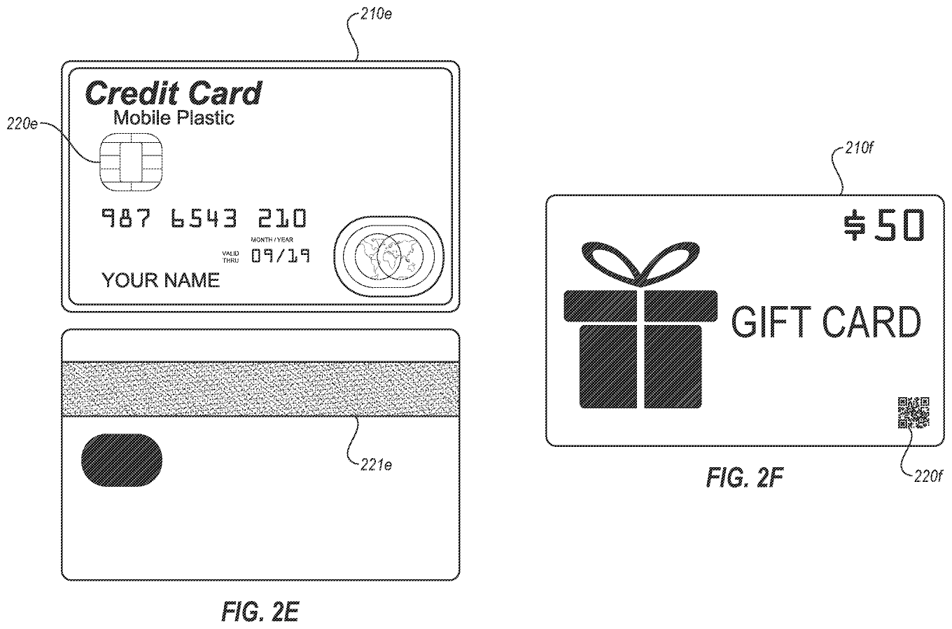

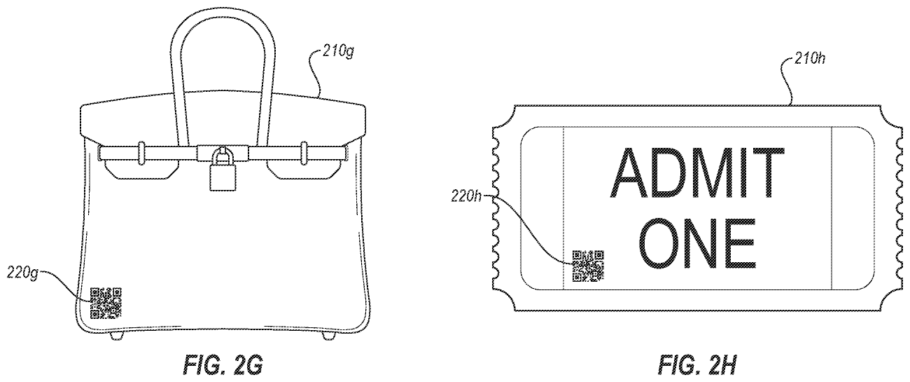

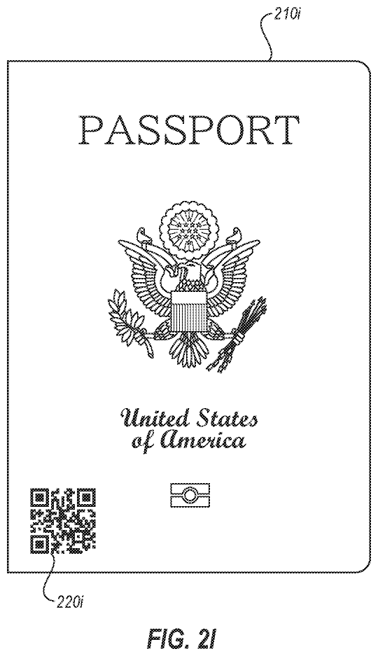

In some embodiments, the computer-scannable media may be attached to a physical object. For example, the QR code 114 may be affixed to an identification badge 112. Other examples of physical objects to which the computer-scannable media may be attached are described with reference to FIGS. 2A-2I.

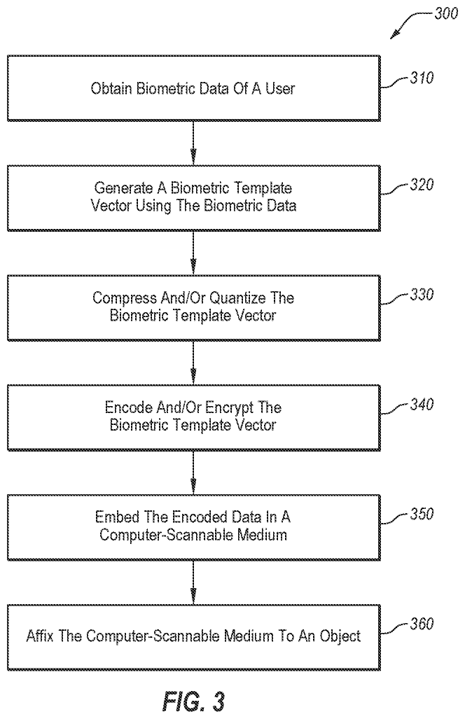

Upon completion of an enrollment process, the user 110 may be in possession of a computer-scannable medium that includes a representation of biometric data of the user 110, for example, as an encoded and/or encrypted biometric template vector. While one example of enrollment is described with reference to FIG. 1, additional examples and/or explanation are included with reference to FIG. 3.

### Verification

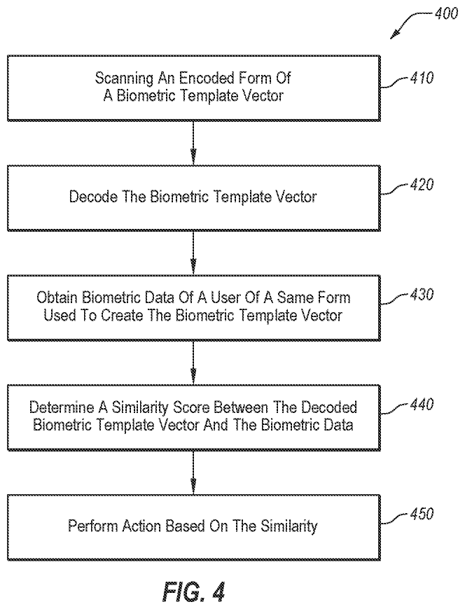

In some embodiments, the user 110 may desire to verify their identity. For example, the user 110 may desire to verify that the user 110 in possession of the ID badge 112 is in fact the individual identified by the ID badge 112. Various examples of verification are described in greater detail with reference to FIGS. 4, 5A, 5B, and 6. To facilitate verification, the user 110 may interact with an authentication device 130. For example, the user 110 may approach the authentication device 130, the user 110 may present the QR code 114 to the authentication device 130, etc. In some embodiments, the authentication device 130 may refrain from initiating a verification process until instigated by the user 110, such as the user 110 presenting the QR code 114, invoking a button on the authentication device 130, walking within a threshold distance of the authentication device 130 when directly facing the authentication device 130, etc., or some other process to initialize verification of the user 110.

During a verification phase, the authentication device 130 may scan the computer-scannable media to obtain the encoded and/or encrypted data of the computer-scannable media (e.g., the biometric template vector). For example, the authentication device 130 may scan the QR code 114 on the ID badge 112 of the user 110 (e.g., by taking a digital image of the QR code 114). As another example, the authentication device 130 may scan an NFC chip, an RFID tag, a magnetic strip, a credit card chip, etc.

During the verification phase, the authentication device 130 may obtain biometric data of the user 110 of the same form used to generate the computer-scannable media during enrollment. For example, if the biometric data includes the facial image 118, the authentication device 130 may capture a second facial image 172 of the user 110 using a camera or other image capturing device. As another example, if the biometric data includes a voice recording, the authentication device 130 may capture a second voice recording of the user 110 using an audio recorder. As an additional example, if the biometric data includes a retinal scan of the user 110, the authentication device 130 may capture a second retinal scan of the user 110 using a retinal scanner. As a further example, if the biometric data includes a fingerprint of the user 110, the authentication device 130 may capture a second fingerprint scan of the user 110 using a fingerprint scanner.

In some embodiments, the authentication device 130 may provide the scanned encoded and/or encrypted biometric template vector and the obtained biometric data to the service 120. For example, the authentication device may invoke an API that provides as an input both the scanned encoded and/or encrypted biometric template vector and the obtained biometric data.

The service 120 may be configured to compare the biometric template vector and the biometric data obtained during the verification phase to confirm that they are both associated with the same individual. For example, the service 120 may perform some or all of the enrollment processing 160 on the obtained facial image 172 to derive data 174 representative of the facial image 172. The service 120 may perform reverse operations of some or all of the enrollment processing 160 on the encoded and/or encrypted biometric template vector to derive data 184 corresponding to the QR code 182. The service 120 may validate that, within a threshold level of confidence, the data 174 representative of the facial image and the data 184 corresponding to the biometric template vector of the QR code 114 belong to the same individual. For example, a similarity score may be determined between the data 174 and the data 184 and a confidence score may be generated based on the similarity score identifying a probability and/or confidence in the probability that the data 174 and the data 184 correspond to biometric data of the same individual. Based on the comparison, the service 120 may generate a verification result 190.

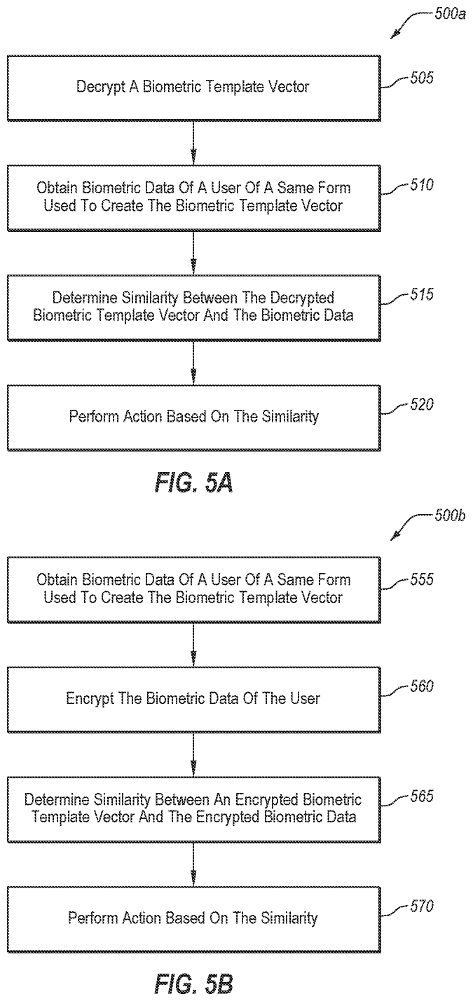

In some embodiments, the service 120 may or may not perform a decryption of the biometric template vector. For example, if the biometric template vector is encrypted using an asymmetric encryption scheme, the service 120 may utilize a private key to decrypt the biometric template vector to facilitate the comparison of the data 174 and the data 184. An example of such a process may be described with reference to FIG. 5A. As another example, if the biometric template vector is encrypted using a homomorphic encryption scheme, the service 120 may retain the biometric template in an encrypted form and/or may encrypt the biometric data obtained during the verification phase to facilitate the comparison of the data 174 and the data 184. An example of such a process may be described with reference to FIG. 5B.

While illustrated as being performed on a back-end server, it will be appreciated that one or more of the operations of the verification phase may be performed locally by the authentication device 130. For example, the authentication device may include programming to scan the computer-scannable media, capture the biometric data, perform a comparison of the biometric template vector obtained from the data from the computer-scannable media and the biometric data, and determine a result of the verification. Additionally or alternatively, some operations may be performed at the authentication device 130 and some may be performed by a back-end server.

In some embodiments, verification of the identity of the user 110 may include verification based on multiple components of biometric data of the user 110. For example, during the enrollment phase, the user 110 may provide both the facial image 118 and a voice recording. Both components of biometric data may be encoded in the QR code 114, and/or the components of biometric data may be encoded in different QR codes (or other computer-scannable media). During the verification phase, one or multiple types of biometric data may be obtained when validating the identity of the user 110. In some embodiments, using multiple components of biometric data may permit varying levels of security and/or confidence in identity verification. For example, a first level of security may validate the identity of the user 110 based on only a voice recording, a second level of security may validate the identity of the user 110 based on only a facial image, and a third level of security may validate the identity of the user 110 based on both a voice recording and a facial image. While the example above uses two components (the facial image 118 and a voice recording), it will be appreciated that any number of components of biometric data may be used to validate the identity of the user 110.

In some embodiments, an action may be performed based on the result of the validation. For example, based on the identity of the user 110 being confirmed (e.g., the identity of the person used to create the QR code 114 is the same as the identity of the person whose facial image 172 is captured), the user 110 may be granted access to a certain area (e.g., a door may be unlocked, a gate may open, an elevator may be called, the user 110 may be granted access to an event or a venue, a locking mechanism may be locked or unlocked, etc.). As another example, based on the identity of the user 110 being confirmed, a result of the validation may be displayed or transmitted for display. In some embodiments, the result may include a numerical value of the confidence score, a similarity score, a probability of identity between the data 174 and the data 184, etc. As a further example, based on the identity of the user 110 being confirmed, a vehicle may be powered on, the ignition started, etc. As an additional example, based on the identity of the user 110 being confirmed, a pending transaction may be completed. As a further example, based on the identity of the user 110 being confirmed, the verification may be transmitted to a third party. While various examples have been provided, it will be appreciated that any action may be undertaken based on verification of the identity of the user 110.

Modifications, additions, or omissions may be made to the system 100 without departing from the scope of the disclosure. For example, the designations of different elements in the manner described is meant to help explain concepts described herein and is not limiting. Further, the system 100 may include any number of other elements or may be implemented within other systems or contexts than those described.

FIGS. 2A-2I are example representations of various environments within which biometric-based identity authentication may be used, in accordance with one or more embodiments of the present disclosure. For example, the FIGS. 2A-2I illustrate various objects 210 (such as the various objects 210a-210i) that have a computer-scannable medium 220 (such as the various computer-scannable media 220a-220i) associated therewith.

FIG. 2A illustrates an ID badge 210a as the object 210 with a QR code 220a as the computer-scannable medium. In some circumstances, the ID badge 210a may be used to provide verification of the identity of the user in gaining access to a location, service, or any other purpose for validating the identity of the user holding the ID badge 210a.

FIG. 2B illustrates a painting 210b as the object 210 with a QR code 220b as the computer-scannable medium. In some circumstances, the painting 210b may have the QR code 220b attached thereto or associated therewith such that the identity of the owner of the painting 210b may be verified.

FIG. 2C illustrates a vehicle 210c as the object 210 with a QR code 220c as the computer-scannable medium. In some circumstances, the vehicle 210c may have the QR code 220b attached thereto or associated therewith such that the identity of an authorized operator of the vehicle 210c may be verified. For example, the identity of the operator may be confirmed prior to the vehicle 210c starting the engine or powering on.

FIG. 2D illustrates a key fob 210d as the object 210 with an RFID tag 220d as the computer-scannable medium. In some circumstances, the key fob 210d may have the RFID tag 220d embedded within it such that as a user attempts to start or unlock a vehicle (or a locked door, etc.), biometric data of the user may be obtained to validate the identity of the user as the owner or an authorized operator of the vehicle prior to starting or unlocking the vehicle (or the locked door, etc.).

FIG. 2E illustrates a credit card 210e as the object 210 with a credit card chip 220e as a first computer-scannable medium and a magnetic strip as a second computer-scannable medium 221e. In some circumstances, when the credit card 210e is used in a transaction, the identity of the cardholder may be verified using the biometric template vector(s) stored on either or both of the credit card chip 220e and/or the magnetic strip 221e. For example, a user at a point of sale (POS) terminal may insert the credit card 210e. The POS terminal may include a digital camera that captures a facial image of the user, and the POS terminal may perform a validation based on the captured facial image and the biometric template vector stored on the credit card chip 220e and/or the magnetic strip 221e to authorize the transaction.

FIG. 2F illustrates a gift card 210f as the object 210 with a QR code 210f as the computer-scannable medium. In some circumstances, the gift card 210f may have the QR code 210f attached thereto such that as a user attempts to use the gift card 210f for a transaction, the identity of the user may be verified as the rightful owner of the gift card 210f.

FIG. 2G illustrates a hand bag 210g as the object 210 with a QR code 220g as the computer-scannable medium. In some circumstances, the hand bag 210g may have the QR code 220g attached thereto or associated therewith such that the identity of the owner of the hang bag 210g may be verified.

FIG. 2H illustrates a ticket 210h as the object 210 with a QR code 210h as the computer-scannable medium. In some circumstances, the ticket 210h may have the QR code 210h attached thereto such that as a user attempts to use the ticket 210h for accessing a venue or an event, the identity of the user may be verified as the rightful owner of the ticket 210h. In some embodiments, such a feature may prevent or control a secondary sale of the ticket 210h as the second owner of the ticket may be prevented from accessing the venue or event as the biometric data of the second owner may not match the biometric template vector associated with the initial purchaser of the ticket 210h.

FIG. 2I illustrates a passport 210i as the object 210 with a QR code 220i as the computer-scannable medium. In some circumstances, the passport 210i may be used to provide verification of the identity of the user in gaining access to an airplane, ship, country, location, service, or any other purpose for validating the identity of the user holding the passport 210i. While a passport is illustrated, it will be appreciated that any travel documents (e.g., visa) are contemplated within the scope of the present disclosure.

Modifications, additions, or omissions may be made to the various environments illustrated in FIGS. 2A-2I without departing from the scope of the disclosure. For example, the designations of different elements in the manner described is meant to help explain concepts described herein and is not limiting. Further, the various objects 210 may include any number of other computer-scannable media 220 and/or may be implemented in any number of objects. Additionally, the objects illustrated in FIGS. 2A-2I are merely illustrative, and any other types or variety of objects are contemplated within the scope of the present disclosure.

FIG. 3 illustrates an example flowchart of an example method 300 of enrolling in an authentication system, in accordance with one or more embodiments of the present disclosure. One or more operations of the method 300 may be performed by a system or device, or combinations thereof, such as the system 100, the mobile device 116, the service 120, and/or the authentication device 130 of FIG. 1. Although illustrated as discrete blocks, various blocks of the method 300 may be divided into additional blocks, combined into fewer blocks, or eliminated, depending on the desired implementation.

At block 310, biometric data of a user may be obtained. For example, a camera may capture an image of the user, a voice recorder may capture a voice recording of the user, a retinal scanner may obtain a retinal scan of the user, a fingerprint scanner may capture a fingerprint scan of the user, etc. In these and other embodiments, the biometric data may be biometric information that may be unique to the user. In some embodiments, multiple components of biometric data may be obtained for the user.

At block 320, a biometric template vector may be generated using the biometric data obtained at the block 310. For example, the facial image (and/or other biometric data) may be converted into a mathematical representation of the facial image (and/or the other biometric data). Such a mathematical representation may include a vector of a set number of values, such as five hundred and twelve floating values.

At block 330, the biometric template vector may be compressed and/or quantized. For example, the biometric template vector may apply a known data compression algorithm or other technique to compress the data. In some embodiments, the block 330 may include compressing the data and re-expanding the data to a same size. For example, the biometric template vector may begin as five hundred and twelve floating values, be compressed, and then be re-expanded to a full set of five hundred and twelve values.

At block 340, the biometric template vector may be encoded and/or encrypted. For example, the biometric template vector may be converted to a format more readily embedded in a QR code or other computer-scannable medium. In some embodiments, the block 340 may include encrypting the biometric template vector using an asymmetric encryption scheme. For example, an authentication system may generate a public-private key pair and may provide the public key to the entity performing the enrollment process such that the biometric template vector may be encrypted using the public key of the authentication system. In some embodiments, the block 340 may include encrypting the biometric template vector using a homomorphic encryption scheme. Such an encryption scheme may permit certain operations to be performed on encrypted data without exposing or decrypting the data. While an asymmetric encryption scheme and a homomorphic encryption scheme are provided as examples, any encryption scheme may be utilized.

At block 350, the encoded data may be embedded into a computer-scannable medium. For example, the output of the block 340 may be embedded into a QR code, stored on an RFID tag, an NFC chip, a credit card chip, a magnetic strip, etc.

At block 360, the computer-scannable medium may be affixed to an object. For example, the QR code may be affixed to an object, the RFID tag/NFC chip may be embedded within an object, the credit card chip and/or the magnetic strip may be affixed to the credit card, etc. In some embodiments, the block 360 may include storing the output of the block 350 on a device such as an RFID tag or an NFC chip.

Modifications, additions, or omissions may be made to the method 300 without departing from the scope of the disclosure. For example, the operations of the method 300 may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

FIG. 4 illustrates an example flowchart of an example method 400 of verification via an authentication system, in accordance with one or more embodiments of the present disclosure. One or more operations of the method 400 may be performed by a system or device, or combinations thereof, such as the system 100, the mobile device 116, the service 120, and/or the authentication device 130 of FIG. 1. Although illustrated as discrete blocks, various blocks of the method 400 may be divided into additional blocks, combined into fewer blocks, or eliminated, depending on the desired implementation.

At block 410, an encoded form of a biometric template vector may be obtained by scanning a computer-scannable medium. For example, a QR code (or other computer-scannable media) generated according to the method 300 of FIG. 3 may be scanned to obtain the encoded form of the biometric template vector.

At block 420, the biometric template vector may be decoded. For example, one or more reverse operations to those performed at any of the blocks 330, 340, and/or 350 may be performed to decode the biometric template vector. In some embodiments, the block 420 may or may not include decrypting the biometric template vector.

At block 430, biometric data of a user may be obtained in a same form as that used to create the biometric template vector. For example, if the biometric template vector was generated using a facial image, the biometric data obtained at the block 430 may include another facial image. In some embodiments, if the biometric template vector is representative of multiple components of biometric data, one or more or all of the different components of biometric data may be obtained at the block 430. For example, if the biometric template vector is representative of a facial image, a voice recording, and a retinal scan, the biometric data obtained at the block 430 may include another facial image, another voice recording, and/or another retinal scan. In some embodiments, the block 430 may include processing of the obtained biometric data to be in a form that may be compared with the biometric template vector.

At block 440, a similarity score between the decoded biometric template vector and the biometric data obtained at the block 430 may be determined. For example, a comparison may be performed to determine whether or not the biometric template vector and the biometric data are associated with the same individual. In some embodiments, the block 440 may include the generation of a probability score, a confidence score, etc. When more than one component of biometric data is used, an independent comparison may be made for each of the components and/or an aggregate or cumulative validation may be performed across multiple components of the biometric data.

At block 450, an action may be performed based on the similarity score determined at the block 440. For example, if the identity of the user is validated based on the similarity score being above a threshold, an action may be performed. Such an action may include displaying a result and/or the score of the validation, transmitting a result of the validation, allowing the user access to a location (e.g., a restricted area, a venue, unlocking a door or a gate, etc.), starting or powering up a vehicle, unlocking a vehicle, authorizing a transaction, etc. If the identity of the user is found to be incorrect (e.g., the user presenting the biometric template vector and whose biometric data is obtained at the block 430 is determined to be different from the user whose biometric information was used to generate the biometric template vector), the action may include denying the user access to a location, displaying the result and/or the score of the validation, transmitting the result of the validation, etc.

Modifications, additions, or omissions may be made to the method 400 without departing from the scope of the disclosure. For example, the operations of the method 400 may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

FIG. 5A illustrates an example flowchart of an example method 500a of verification via an authentication system using an asymmetric encryption scheme, in accordance with one or more embodiments of the present disclosure. One or more operations of the method 500a may be performed by a system or device, or combinations thereof, such as the system 100, the mobile device 116, the service 120, and/or the authentication device 130 of FIG. 1. Although illustrated as discrete blocks, various blocks of the method 500a may be divided into additional blocks, combined into fewer blocks, or eliminated, depending on the desired implementation. In some embodiments, the method 500a may be a portion of another method of the present disclosure. For example, the method 500a may be a continuation of the method 400 of FIG. 4 after the block 410 and/or 420 of FIG. 4. As another example, the method 500a may be a replacement of one or more of the blocks 410-450 the method 400 of FIG. 4. The method 500a may represent operations that may be performed when the biometric template vector is encrypted using an asymmetric encryption scheme.

At block 505, an obtained biometric template vector may be decrypted. For example, an authentication system, a security device, an associated service, etc. may obtain a biometric template vector encrypted using an asymmetric encryption scheme. For example, the biometric template vector may have been previously encrypted using a public key of the authentication system, and may be decrypted using a corresponding private key of the authentication system.

At block 510, biometric data of a user may be obtained that is of a same form as the biometric data used as the basis for the biometric template vector. For example, if the biometric template vector was generated using a facial image, the obtained biometric data may include a facial image. In some embodiments, the authentication system, the security device, etc. may capture the biometric data using a sensor such as a camera, retinal scanner, audio recorder, fingerprint scanner, etc. Additionally or alternatively, the authentication system, the security device, etc. may receive the biometric data from another device.

At block 515, a similarity between the decrypted biometric template vector and the biometric data may be determined. The block 515 may be similar or comparable to the block 440 of FIG. 4. In some embodiments, the similarity may be determined using the decrypted biometric template vector and an unencrypted from of the biometric data obtained at the block 510.

At block 520, an action may be performed based on the similarity. The block 520 may be similar or comparable to the block 450 of FIG. 4.

Modifications, additions, or omissions may be made to the method 500a without departing from the scope of the disclosure. For example, the operations of the method 500a may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

FIG. 5B illustrates an example flowchart of an example method 500b of verification via an authentication system using a homomorphic encryption scheme, in accordance with one or more embodiments of the present disclosure. One or more operations of the method 500b may be performed by a system or device, or combinations thereof, such as the system 100, the mobile device 116, the service 120, and/or the authentication device 130 of FIG. 1. Although illustrated as discrete blocks, various blocks of the method 500b may be divided into additional blocks, combined into fewer blocks, or eliminated, depending on the desired implementation. In some embodiments, the method 500a may be a portion of another method of the present disclosure. For example, the method 500a may be a continuation of the method 400 of FIG. 4 after the block 410 and/or 420 of FIG. 4. As another example, the method 500a may be a replacement of one or more of the blocks 410-450 the method 400 of FIG. 4. The method 500b may represent operations that may be performed when the biometric template vector is encrypted using a homomorphic encryption scheme.

At block 555, biometric data of a user may be obtained that is of a same form as biometric data used as the basis for an encrypted biometric template vector. For example, if the biometric template vector was generated using a facial image, the obtained biometric data may include a facial image. In some embodiments, the authentication system, the security device, etc. may capture the biometric data using a sensor such as a camera, retinal scanner, audio recorder, fingerprint scanner, etc. Additionally or alternatively, the authentication system, the security device, etc. may receive the biometric data from another device.

At block 560, the biometric data of the user may be encrypted using the same encryption scheme used to encrypt the biometric template vector. For example, if the biometric template vector is encrypted using a given key and a homomorphic encryption scheme, the biometric data may be encrypted using the given key and the homomorphic encryption scheme.

At block 565, a similarity between the encrypted biometric template vector and the encrypted biometric data may be determined. In some embodiments, by having the biometric template vector and the biometric data encrypted using the same encryption scheme, certain mathematical functions and operations, such as the comparison and/or determination of the similarity, may be performed without decrypting either or both of the biometric template vector and the biometric data. In these and other embodiments, the similarity may be determined with or without decrypting either or both of the biometric template vector and the biometric data. The block 565 may be similar or comparable to the block 440 of FIG. 4. For example, the block 565 may include determination of a similarity score, a probability of the same person being associated with both the biometric template vector and the biometric data, a confidence score, etc.

At block 570, an action may be performed based on the similarity. The block 570 may be similar or comparable to the block 450 of FIG. 4.

Modifications, additions, or omissions may be made to the method 500b without departing from the scope of the disclosure. For example, the operations of the method 500b may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

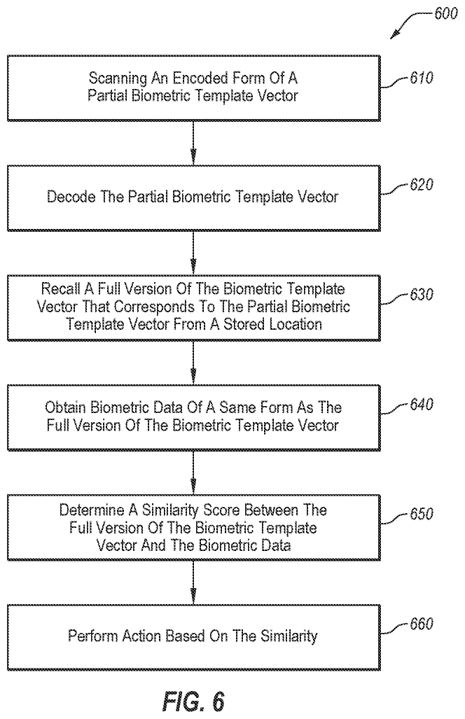

FIG. 6 illustrates an example flowchart of an example method 600 of verification via an authentication system using a partial biometric template vector, in accordance with one or more embodiments of the present disclosure. One or more operations of the method 600 may be performed by a system or device, or combinations thereof, such as the system 100, the mobile device 116, the service 120, and/or the authentication device 130 of FIG. 1. Although illustrated as discrete blocks, various blocks of the method 600 may be divided into additional blocks, combined into fewer blocks, or eliminated, depending on the desired implementation.

At block 610, an encoded form of a partial biometric template vector may be scanned. For example, a QR code, an RFID chip, NFC chip, credit card chip, etc. or any other computer-scannable medium may include a limited amount of storage. In these and other embodiments, the amount of storage may be lower than a full version of the encoded biometric template vector. In these and other embodiments the computer-scannable medium may have stored thereon the partial biometric template vector. The computer-scannable medium may be scanned by a QR code scanner, an RFID chip reader, an NFC chip reader, etc. to obtain the partial biometric template vector. In some embodiments, an identifier associated with the biometric template vector may also be obtained.

At block 620, the partial biometric template vector may be decoded. The block 620 may be similar or comparable to the block 420, but operating on the partial biometric template vector.

At block 630, a full version of the biometric template vector that corresponds to the partial biometric template vector may be recalled from a stored location. For example, a security device, authentication system, etc. may store the full version of the biometric template vector at the stored location during an enrollment phase or at some point after an enrollment phase and before verification of the user associated with the biometric template vector. In some embodiments identifying the full version of the biometric template vector may or may not be based, at least in part, on the identifier associated with the biometric template vector.

In some embodiments, when recalling the full version of the biometric template vector, the remainder of the full version may be recalled. For example, if the partial biometric template vector decoded at the block 620 included an initial one third of the full version of the biometric template vector, the block 620 may include recalling the remaining two thirds of the full version of the biometric template vector and combining the two to obtain the complete full version of the biometric template vector.

At block 640, biometric data of a user may be obtained that is of a same form as the biometric data used as the basis for the full version of the biometric template vector. For example, if the full version of the biometric template vector was generated using a facial image, the obtained biometric data may include a facial image. In some embodiments, the authentication system, the security device, etc. may capture the biometric data using a sensor such as a digital camera, retinal scanner, audio recorder, fingerprint scanner, etc. Additionally or alternatively, the authentication system, the security device, etc. may receive the biometric data from another device. The block 640 may be similar or comparable to the block 430 of FIG. 4.

At block 650, a similarity score between the full version of the biometric template vector recalled at the block 630 and the biometric data obtained at the block 640 may be determined. The block 650 may be similar or comparable to the block 440 of FIG. 4, except operating on the full version of the biometric template vector recalled at the block 630 and the biometric data obtained at the block 640.

At block 660, an action may be performed based on the similarity. The block 660 may be similar or comparable to the block 450 of FIG. 4.

Modifications, additions, or omissions may be made to the method 600 without departing from the scope of the disclosure. For example, the operations of the method 600 may be implemented in differing order. Additionally or alternatively, two or more operations may be performed at the same time. Furthermore, the outlined operations and actions are provided as examples, and some of the operations and actions may be optional, combined into fewer operations and actions, or expanded into additional operations and actions without detracting from the essence of the disclosed embodiments.

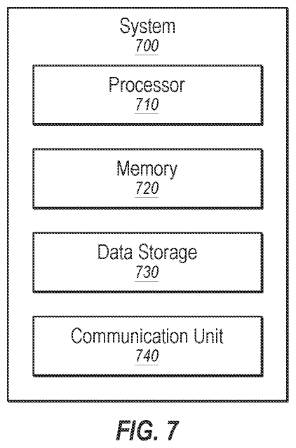

FIG. 7 illustrates an example computing system 700, according to at least one embodiment described in the present disclosure. The computing system 700 may include a processor 710, a memory 720, a data storage 730, and/or a communication unit 740, which all may be communicatively coupled. Any or all of the system 100 of FIG. 1 may be implemented as a computing system consistent with the computing system 700, including the mobile device 116, the service 120, and/or the authentication device 130.

Generally, the processor 710 may include any suitable special-purpose or general-purpose computer, computing entity, or processing device including various computer hardware or software modules and may be configured to execute instructions stored on any applicable computer-readable storage media. For example, the processor 710 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 7, it is understood that the processor 710 may include any number of processors distributed across any number of network or physical locations that are configured to perform individually or collectively any number of operations described in the present disclosure. In some embodiments, the processor 710 may interpret and/or execute program instructions and/or process data stored in the memory 720, the data storage 730, or the memory 720 and the data storage 730. In some embodiments, the processor 710 may fetch program instructions from the data storage 730 and load the program instructions into the memory 720.

After the program instructions are loaded into the memory 720, the processor 710 may execute the program instructions, such as instructions to perform any of the methods 300, 400, 500a, 500b, and/or 600 of FIGS. 3-6, respectively. For example, the processor 710 may obtain instructions regarding encrypting attributes of users, posting information to the blockchain, and/or otherwise facilitating the exchange of reputable credentials.

The memory 720 and the data storage 730 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 710. For example, the memory 720 and/or the data storage 730 may store a biometric template vector, biometric data, etc. In some embodiments, the computing system 700 may or may not include either of the memory 720 and the data storage 730.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 710 to perform a certain operation or group of operations.

The communication unit 740 may include any component, device, system, or combination thereof that is configured to transmit or receive information over a network. In some embodiments, the communication unit 740 may communicate with other devices at other locations, the same location, or even other components within the same system. For example, the communication unit 740 may include a modem, a network card (wireless or wired), an optical communication device, an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, or others), and/or the like. The communication unit 740 may permit data to be exchanged with a network and/or any other devices or systems described in the present disclosure. For example, the communication unit 740 may allow the system 700 to communicate with other systems, such as computing devices and/or other networks.

One skill in the art, after reviewing this disclosure, may recognize that modifications, additions, or omissions may be made to the system 700 without departing from the scope of the present disclosure. For example, the system 700 may include more or fewer components than those explicitly illustrated and described.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and processes described herein are generally described as being implemented in software (stored on and/or executed by general purpose hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc. are not necessarily used herein to connote a specific order. Generally, the terms “first,” “second,” “third,” etc., are used to distinguish between different elements. Absence a showing of a specific that the terms “first,” “second,” “third,” etc. connote a specific order, these terms should not be understood to connote a specific order.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that various changes, substitutions, and alterations could be made hereto without departing from the spirit and scope of the present disclosure.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method of enrolling in an authentication system, comprising:
obtaining biometric data of a user;
generating a biometric template vector using the biometric data;
encrypting the biometric template vector; and
embedding the encrypted biometric template vector into a computer-scannable medium.

2. The method of claim 1, further comprising compressing the biometric template vector before encrypting the biometric template vector.

3. The method of claim 1, wherein the computer-scannable medium includes at least one of a quick response (QR) code, a radio frequency identification (RFID) tag, a near-field communication (NFC) tag, a magnetic strip, or a credit card chip.

4. The method of claim 1, further comprising affixing the computer-scannable medium to one of an identification (ID) card, a travel document, and a key.

5. The method of claim 1, wherein obtaining the biometric data of the user includes receiving the biometric data as scanned by a mobile device of the user.

6. The method of claim 1, wherein the biometric data includes at least one of a facial image of the user, a voice recording of the user, a retinal scan of the user, and a fingerprint of the user.

7. The method of claim 1, further comprising:
obtaining second biometric data of the user;
generating a second biometric template vector using the second biometric data;
encrypting the second biometric template vector; and
embedding the second encrypted biometric template vector into the computer-scannable medium.

8. A method of verification via an authentication system, comprising:
obtaining an encrypted and encoded form of a biometric template vector associated with a user;
decoding the biometric template vector;
obtaining biometric data of the user of a same form used to create the biometric template vector;
determining a similarity score between the decoded biometric template vector and the biometric data; and
performing an action based on the similarity score.

9. The method of claim 8, wherein performing the action includes, based on the similarity score exceeding a threshold, performing at least one of:
transmitting a verification of the user to a third party;
displaying a verification of the user;
granting the user access to a location; and
starting a vehicle.

10. The method of claim 8, wherein obtaining the encrypted and encoded form of the biometric template vector includes scanning a computer-scannable medium, including at least one of:
capturing a digital image of a quick response (QR) code and processing the QR code to obtain the encoded form of the biometric template vector as embedded in the QR code;
scanning a radio frequency identification (RFID) tag to read the encoded form of the biometric template vector as stored by the RFID tag;
scanning a near-field communication (NFC) tag to read the encoded form of the biometric template vector as stored by the NFC tag;
scanning a magnetic strip to read the encoded form of the biometric template vector as stored by the magnetic strip; and
scanning a credit card chip to read the encoded form of the biometric template vector as stored by the credit card chip.

11. The method of claim 8, wherein obtaining biometric data of the user includes at least one of:
capturing a digital image of a face of the user when a previous digital image of the face of the user was used to create the biometric template vector;
recording a voice of the user when a previous voice recording of the user was used to create the biometric template vector;
scanning a retina of the user when a previous retinal scan of the user was used to create the biometric template vector; and
scanning a fingerprint of the user when a previous fingerprint of the user was used to create the biometric template vector.

12. The method of claim 8, wherein the biometric template vector is encrypted using an asymmetric encryption scheme, the biometric template vector encrypted using a public key associated with the authentication system, the method further comprising decrypting the biometric template vector using a private key corresponding to the public key.

13. The method of claim 8, wherein the biometric template vector is encrypted using a homomorphic encryption scheme, the method further comprising encrypting the biometric data of the user using the homomorphic encryption scheme, and wherein determining the similarity score is performed without decrypting the biometric template vector.

14. The method of claim 8, wherein obtaining the encrypted and encoded form of the biometric template vector includes:
receiving a portion of the biometric template vector from a remote device; and
recalling at least a remainder of the biometric template vector such that a combination of the portion and the remainder is a full version of the biometric template vector.

15. The method of claim 14, wherein recalling at least the remainder includes recalling the full version of the biometric template vector.

16. An authentication system, comprising:
a scanner for accessing computer-scannable media;
a sensor for obtaining biometric data;
one or more processor; and
one or more non-transitory computer-readable media containing instructions that, when executed by the one or more processors, are configured to cause the authentication system to perform operations, the operations comprising:
instructing the scanner to scan the computer-scannable media to obtain an encrypted and encoded form of a biometric template vector associated with a user;
decoding the biometric template vector;
reading biometric data of a user as sensed by the sensor, the biometric data of the user of a same form used to create the biometric template vector;
determining a similarity score between the decoded biometric template vector and the biometric data; and
performing an action based on the similarity score.

17. The authentication system of claim 16, further comprising at least one of a communication device, a display, a locking mechanism, and an ignition, and wherein performing the action includes, based on the similarity score exceeding a threshold, performing at least one of:
transmitting a verification of the user to a third party via the communication device;
displaying a verification of the user on the display;
granting the user access to a location by unlocking the locking mechanism; and
starting the ignition.

18. The authentication system of claim 16, wherein the sensor includes at least one of a digital camera, an audio recorder, a retinal scanner, and a fingerprint scanner, and wherein obtaining biometric data of the user includes at least one of:
capturing a digital image of a face of the user using the digital camera when a previous digital image of the face of the user was used to create the biometric template vector;
recording a voice of the user using the audio recorder when a previous voice recording of the user was used to create the biometric template vector;
scanning a retina of the user using the retinal scanner when a previous retinal scan of the user was used to create the biometric template vector; and
scanning a fingerprint of the user using the fingerprint scanner when a previous fingerprint of the user was used to create the biometric template vector.

19. The authentication system of claim 16,
wherein the biometric template vector is encrypted using an asymmetric encryption scheme, the biometric template vector encrypted using a public key associated with the authentication system; and
wherein the operations further comprise decrypting the biometric template vector using a private key corresponding to the public key.

20. The authentication system of claim 16,
wherein the biometric template vector is encrypted using a homomorphic encryption scheme;
wherein the operations further comprise encrypting the biometric data of the user using the homomorphic encryption scheme; and
wherein determining the similarity score is performed without decrypting the biometric template vector.
